(19) United States
(12) Patent Application Publication
(10) Pub. No.: US 2026/0246537 A1
(43) Pub. Date: Aug. 20, 2026

(54) OPTICAL MODULE WITH PARAMETER TABLE

(71) Applicant: Cisco Technology, Inc., San Jose, CA (US)

(72) Inventors: Marco MAZZINI, Seville (ES); Fabio BOTTONI, Milan (IT); Alberto CERVASIO, Cuorgne' (IT)

(21) Appl. No.: 19/055,445

(22) Filed: Feb. 17, 2025

(51) Int. Cl. H04B 10/54; H04B 10/524

(52) U.S. Cl. CPC H04B 10/541; H04B 10/524

(57) ABSTRACT

The present disclosure describes an optical module with stored operating parameters. According to an embodiment, an optical module includes an equalizer, a first driver, a modulator, and a memory. The equalizer adjusts a first electrical signal. The first driver adjusts the first electrical signal received from the equalizer. The modulator produces a first optical signal based on the first electrical signal received from the first driver. The memory stores a lookup table that includes a first entry and a second entry. The first entry indicates a first impulse response at a transmission port of the optical module and a first equalization parameter for the first impulse response. The second entry indicates a second impulse response at the transmission port and a second equalization parameter for the second impulse response.

### TECHNICAL FIELD

Embodiments presented in this disclosure generally relate to optical modules. More specifically, embodiments disclosed herein relate to an optical module with a parameter table.

### BACKGROUND

Advancements in communications networks and artificial intelligence systems have driven the need for power consumption reductions in optical modules that convert electrical signals into optical signals. One solution that has emerged is a linear pluggable optical module. This type of optical module includes linear optical drivers, which allows for elimination of the digital signal processor (DSP) present in other optical modules. The electrical interface to the host is formed using a transimpedance amplifier and, from the host, a driver chip with high analog linearity and equalization capabilities, which reduces the power consumption of the optical module relative to other optical modules that use DSPs.

One challenge when using a linear pluggable optical module is setting operating parameters for the optical module (e.g., equalizer tap weights). Additionally, setting the operating parameters may become more challenging if the optical module does not monitor forward error correction (FEC) statistics—FEC termination or regeneration may not be used to protect the links. As a result, it may be challenging to adopt and use the linear pluggable optical module.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example optical system.

FIG. 2 illustrates a block diagram of an example optical module in the optical system of FIG. 1.

FIG. 3 illustrates an example host device in the optical system of FIG. 1.

FIG. 4 illustrates an example lookup table in the optical system of FIG. 1.

FIG. 5 illustrates an example operation performed by the optical system of FIG. 1.

FIG. 6 illustrates an example test system.

FIG. 7 is a flowchart of an example method performed by the optical system of FIG. 1.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes an optical module with stored operating parameters. According to an embodiment, an optical module includes an equalizer, a first driver, a modulator, and a memory. The equalizer adjusts a first electrical signal. The first driver adjusts the first electrical signal received from the equalizer. The modulator produces a first optical signal based on the first electrical signal received from the first driver. The memory stores a lookup table that includes a first entry and a second entry. The first entry indicates a first impulse response at a transmission port of the optical module and a first equalization parameter for the first impulse response. The second entry indicates a second impulse response at the transmission port and a second equalization parameter for the second impulse response.

According to another embodiment, a device includes one or more memories and one or more processors communicatively coupled to the one or more memories. The one or more processors, individually or collectively, perform an operation that includes retrieving, from an optical module connected to the device, a portion of a lookup table stored in a memory of the optical module. The portion of the lookup table includes a first entry indicating a first impulse response at a transmission port of the optical module and a first equalization parameter for the first impulse response and a second entry indicating a second impulse response at the transmission port and a second equalization parameter for the second impulse response. The operation also includes adjusting, by the device, an equalizer of the optical module using the retrieved portion of the lookup table.

According to another embodiment, a method includes retrieving, by a host device and from an optical module connected to the host device, a portion of a lookup table stored in a memory of the optical module. The portion of the lookup table includes a first entry and a second entry. The first entry indicates a first impulse response at a transmission port of the optical module and a first equalization parameter for the first impulse response. The second entry indicates a second impulse response at the transmission port and a second equalization parameter for the second impulse response. The method also includes adjusting, by the host device, an equalizer of the optical module using the retrieved portion of the lookup table.

### EXAMPLE EMBODIMENTS

The present disclosure describes an optical module (e.g., a linear transmitter optical module, linear receive optical module, linear pluggable optical module, etc.) with a memory that stores a lookup table of parameters for different operating conditions experienced by the optical module. For example, the lookup table may include operating parameters for different impulse responses. When the optical module is connected to a host device, the host device may determine the impulse response of the optical module, and the host device may determine, from the lookup table, the operating parameters that correspond to the determined impulse response. The host device may then adjust the optical module (e.g., adjust the equalizer of the optical module) using these operating parameters.

The operating parameters in the lookup table may be determined using a test setup. For example, the optical module may be connected to a test board, reference transmitter, and a reference receiver. The test setup may generate and direct test signals to and from the optical module to determine how the optical module responds to the test signals. The test setup may then determine the operating parameters for the optical module using the responses from the optical module. The test setup may then store the operating parameters into the lookup table in the optical module.

In certain embodiments, the optical module provides several technical advantages. For example, the lookup table may allow the operation of the optical module to be adjusted to accommodate different impulse responses. As a result, the optical module may provide improved performance relative to existing optical modules. For example, the optical module may reduce the amount of time and complexity of link training.

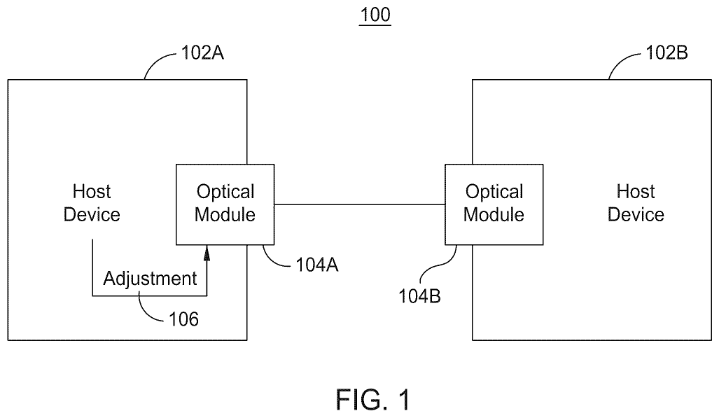

FIG. 1 illustrates an example optical system 100. As seen in FIG. 1, the optical system 100 includes a host device 102A, a host device 102B, an optical module 104A, and an optical module 104B. Generally, the optical module 104A and the optical module 104B may communicate optical signals to each other over an optical connection (which may also be referred to as an optical link).

The host devices 102A and 102B may be electronic devices that connect with the optical modules 104A and 104B. For example, the host devices 102A and 102B may be computers, servers, access points, routers, or any other electronic devices that transmit and receive electrical signals to communicate with other devices. The host devices 102A and 102B may provide interfaces (e.g., ports) to which the optical modules 104A and 104B connect. After the host devices 102A and 102B are connected with the optical modules 104A and 104B, the host devices 102A and 102B may communicate electrical signals to and from the optical modules 104A and 104B. For example, the host device 102A may transmit electrical signals that include data for another device (e.g., the host device 102B). The optical module 104A may convert those electrical signals into optical signals that include the data. The optical module 104A then transmits the optical signals towards their destination. As another example, the optical module 104A may receive an optical signal that includes data. The optical module 104A may convert the optical signal into an electrical signal that includes the data. The optical module 104A then directs the electrical signal to the host device 102A, and the host device 102A may process the data in the electrical signals.

The optical modules 104A and 104B may be optical transceivers (e.g., linear transmitter optical transceivers, linear receive optical transceivers, linear pluggable optical transceivers, etc.). The optical module 104A may be connected to (e.g., inserted into) the host device 102A, and the optical module 104B may be connected to (e.g., inserted into) the host device 102B. The host device 102A may direct an electrical signal carrying data or information to the optical module 104A. The optical module 104A may produce an optical signal that has been modulated with the data or information in the electrical signal. The optical module 104A may then direct the optical signal to the optical module 104B. The optical module 104B may convert the optical signal into an electrical signal carrying the data or information, and the optical module 104B may direct that electrical signal to the host device 102B. In this example communication, the host device 102A acts as a transmitter in the optical system 100, and the host device 102B acts as a receiver in the optical system 100. A similar communication pathway may be conducted in reverse in the optical system 100. In the reverse communication pathway, the host device 102B serves as the transmitter, and the optical module 104B produces an optical signal based on an electrical signal from the host device 102B. The optical module 104A then converts the optical signal from the optical module 104B into an electrical signal for the host device 102A, which serves as the receiver.

The optical modules 104A and 104B may include ports (e.g., transmission ports and receiver ports) that provide a physical interface through connections to host devices 102 and other optical modules 104 may be formed. For example, the optical modules 104A and 104B may include transmission ports used to connect with the respective host devices 102A and 102B. The optical modules may use these transmission ports to direct electrical signals to the respective host devices 102A and 102B. The optical modules 104A and 104B may also include transmission ports used to connect with other optical module 104B or 104A. The optical modules 104A and 104B may use these transmission ports to direct optical signals to the other optical module 104B or 104A. The optical modules 104A and 104B may also include receive ports to receive electrical signals from the respective host devices 102A and 102B and/or to receive optical signals from the other optical module 104B or 104A.

The optical modules 104A and 104B may include equalizers that adjust the electrical signals from the host devices 102A and 102B, respectively. These adjustments may counteract distortions introduced by the optical connection (e.g., the optic fiber) into the optical signals communicated between the optical modules 104A and 104B. In some instances, these adjustments adjust the amplitude of the electrical signals across different frequencies, which may improve signal quality and ensure reliable data transmission over long distances. In existing optical modules, the parameters for the equalizers may be set using a process called link training. During link training, the optical modules may exchange training patterns and negotiate parameters (e.g., the equalizer parameters).

In the system 100, the optical module 104A may store a lookup table that includes operating parameters for the optical module 104A. For example, these operating parameters may be for different impulse responses of the optical module 104A. The host device 102A may determine the impulse response of the optical module 104A. The host device 102A may then refer to the lookup table to determine the operating parameters corresponding to the determined impulse response. The host device 102A may then set the operating parameters for the optical module 104A (e.g., equalization parameters such as the tap weights of the equalizer in the optical module 104A) using the operating parameters from the lookup table and corresponding to the determined impulse response. For example, the host device 102A may determine and direct an adjustment 106 to the optical module 104A. The adjustment 106 may set the operating parameters of the optical module 104A, as determined by the host device 102A. In some embodiments, by using the lookup table to determine the adjustment 106, the optical system 100 may reduce the time and complexity of the link training process.

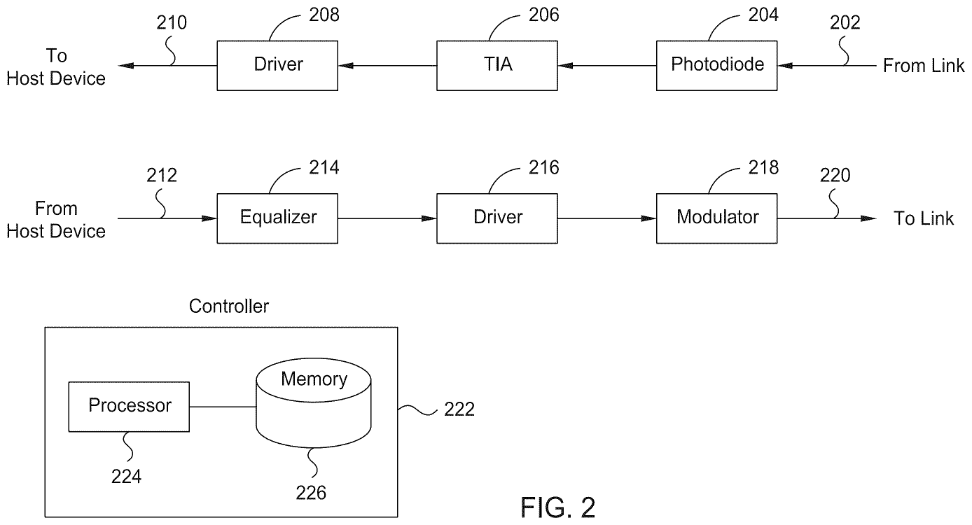

FIG. 2 illustrates a block diagram of an example optical module 104 in the optical system 100 of FIG. 1. As seen in FIG. 2, the optical module 104 includes a receive port 202, a photodiode 204, a transimpedance amplifier 206, a driver 208, a transmission port 210, a receive port 212, an equalizer 214, a driver 216, a modulator 218, a transmission port 220, and a controller 222.

The receive port 202 may be connected to an optical link (e.g., to another optical module). The photodiode 204 receives, through the receive port 202, an optical signal carrying data and converts that optical signal into an electrical signal. For example, the photodiode 204 may convert a received optical signal into an electric current. The magnitude of the electric current may depend on the intensity or content of the optical signal. The transimpedance amplifier 206 converts the electric current into a voltage signal. The driver 208 then conditions the voltage signal for a host device, and the optical module 104 may communicate the voltage signal to the host device through the transmission port 210. The host device may extract data from the voltage signal and process that data.

The host device also transmits electrical signals that carry data. For example, the host device may transmit electric voltages and/or current that carry data to the optical module 104 through the transmission port 212. The equalizer 214 adjusts the electrical signal from the host device to mitigate impairments introduced by the optical link. By mitigating the impairments, or losses introduced by the optical link, the receiving device may correctly extract the data from the signal.

The driver 216 adjusts the voltage and/or current from the equalizer 214. As a result, the driver 216 conditions the electrical signal from the equalizer 214 for the modulator 218. The modulator 218 modulates an optical signal (e.g., from an optical source such as a laser) with the data in the electrical signal from the driver 216. In this manner, the modulator 218 generates an optical signal that carries the data from the host device. The modulator 218 transmits the generated optical signal through the transmission port 220 to the optical link. In this manner, the optical module 104 transmits data from the host device as an optical signal.

The controller 222 may manage or control the operation of the optical module 104. As seen in FIG. 2, the controller 222 may include a processor 224 and a memory 226, which may perform the functions or actions of the optical module 104 described herein. In certain embodiments, the memory 226 stores a lookup table of operating parameters that the host device may use to adjust the optical module 104.

The processor 224 is any electronic circuitry, including, but not limited to one or a combination of microprocessors, microcontrollers, application specific integrated circuits (ASIC), application specific instruction set processor (ASIP), and/or state machines, that communicatively couples to the memory 226 and controls the operation of the optical module 104. The processor 224 may be 8-bit, 16-bit, 32-bit, 64-bit or of any other suitable architecture. The processor 224 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 224 may include other hardware that operates software to control and process information. The processor 224 executes software stored on the memory 226 to perform any of the functions described herein. The processor 224 controls the operation and administration of the optical module 104 by processing information (e.g., information received from host devices and the memory 226). The processor 224 is not limited to a single processing device and may encompass multiple processing devices contained in the same device or computer or distributed across multiple devices or computers. The processor 224 is considered to perform a set of functions or actions if the multiple processing devices collectively perform the set of functions or actions, even if different processing devices perform different functions or actions in the set.

The memory 226 may store, either permanently or temporarily, data, operational software, or other information for the processor 224. The memory 226 may include any one or a combination of volatile or non-volatile local or remote devices suitable for storing information. For example, the memory 226 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 226, a disk, a CD, or a flash drive. In particular embodiments, the software may include an application executable by the processor 224 to perform one or more of the functions described herein. The memory 226 is not limited to a single memory and may encompass multiple memories contained in the same device or computer or distributed across multiple devices or computers. The memory 226 is considered to store a set of data, operational software, or information if the multiple memories collectively store the set of data, operational software, or information, even if different memories store different portions of the data, operational software, or information in the set.

In some embodiments, the memory 226 stores a lookup table of operating parameters for the optical module 104. The host device connected to the optical module 104 may retrieve the lookup table or portions of the lookup table from the memory 226. The host device may then use the operating parameters in the lookup table to adjust the optical module 104 for the operating conditions experienced by the optical module 104. For example, the lookup table may include operating parameters for different impulse responses of the optical module 104. The host device may determine the impulse response of the optical module 104 and then adjust the optical module 104 (e.g., adjust the equalizer 214) using the operating parameters in the lookup table corresponding to the determined impulse response.

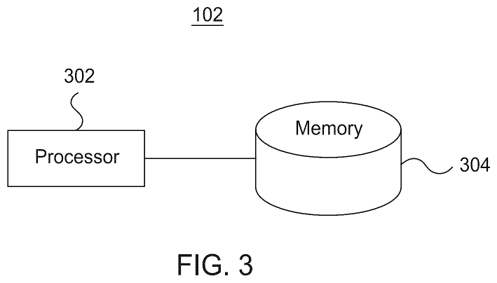

FIG. 3 illustrates an example host device 102 in the optical system 100 of FIG. 1. As seen in FIG. 3, the host device 102 includes a processor 302 and a memory 304, which may perform the functions or actions of the host device 102 described herein.

The processor 302 is any electronic circuitry, including, but not limited to one or a combination of microprocessors, microcontrollers, application specific integrated circuits (ASIC), application specific instruction set processor (ASIP), and/or state machines, that communicatively couples to the memory 304 and controls the operation of the host device 102. The processor 302 may be 8-bit, 16-bit, 32-bit, 64-bit or of any other suitable architecture. The processor 302 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 302 may include other hardware that operates software to control and process information. The processor 302 executes software stored on the memory 304 to perform any of the functions described herein. The processor 302 controls the operation and administration of the host device 102 by processing information (e.g., information received from an optical module and the memory 304). The processor 302 is not limited to a single processing device and may encompass multiple processing devices contained in the same device or computer or distributed across multiple devices or computers. The processor 302 is considered to perform a set of functions or actions if the multiple processing devices collectively perform the set of functions or actions, even if different processing devices perform different functions or actions in the set.

The memory 304 may store, either permanently or temporarily, data, operational software, or other information for the processor 302. The memory 304 may include any one or a combination of volatile or non-volatile local or remote devices suitable for storing information. For example, the memory 304 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 304, a disk, a CD, or a flash drive. In particular embodiments, the software may include an application executable by the processor 302 to perform one or more of the functions described herein. The memory 304 is not limited to a single memory and may encompass multiple memories contained in the same device or computer or distributed across multiple devices or computers. The memory 304 is considered to store a set of data, operational software, or information if the multiple memories collectively store the set of data, operational software, or information, even if different memories store different portions of the data, operational software, or information in the set.

In some embodiments, the processor 302 retrieves, from an optical module, a lookup table of operating parameters for different impulse responses. The processor 302 may also determine the impulse response of the optical module and the operating parameters from the lookup table corresponding to the determined impulse response. The processor 302 may then adjust the optical module (e.g., adjust the equalization parameters of an equalizer of the optical module) using the determined operating parameters.

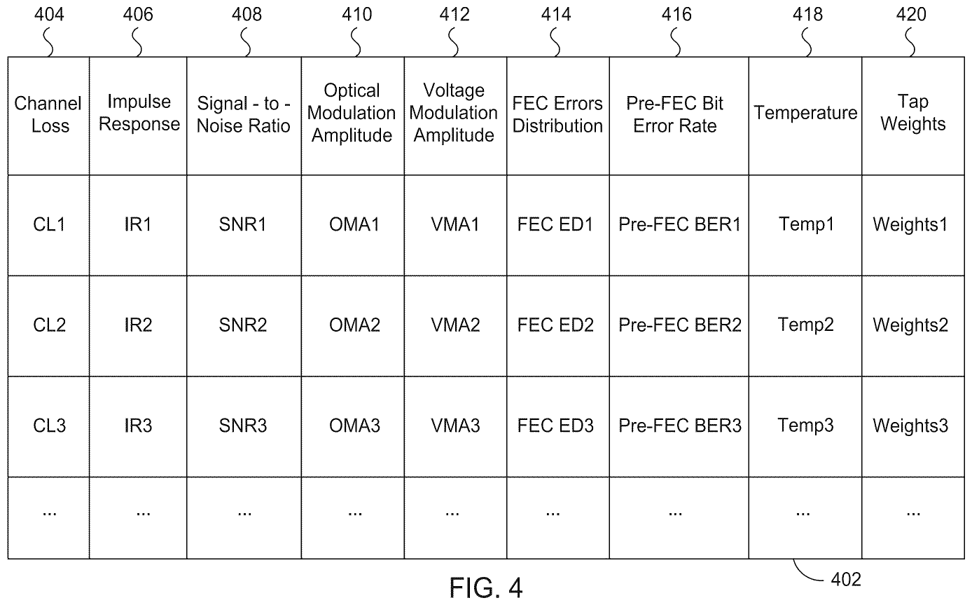

FIG. 4 illustrates an example lookup table 402 in the optical system 100 of FIG. 1. As discussed above, the lookup table 402 may be stored in a memory of an optical module. Generally, the lookup table 402 includes operating parameters for the optical module. A host device connected to the optical module may use the operating parameters in the lookup table 402 to adjust the optical module.

As seen in FIG. 4, each row of the lookup table 402 may be an entry in the lookup table 402 that includes operating parameters and different operating conditions. The lookup table 402 includes a column 404 indicating channel losses for each entry, a column 406 indicating impulse responses for each entry, a column 408 indicating signal-to-loss ratios for each entry, a column 410 indicating optical modulation amplitudes for each entry, a column 412 indicating voltage modulation amplitudes for each entry, a column 414 indicating forward error correction errors distribution for each entry, a column 416 indicating pre-forward error correction bit error rates for each entry, a column 418 indicating temperatures for each entry, and a column 420 indicating tap weights for each entry. The lookup table 402 may include any number of columns that indicate any number of operating parameters or operating conditions. Additionally, the lookup table 402 may include any number of rows or entries.

In the example of FIG. 1, a first entry indicates a channel loss of CL1, an impulse response of IR1, a signal-to-noise ratio of SNR1, an optical modulation amplitude of OMA1, a voltage modulation amplitude of VMA1, a forward error correction errors distribution of FED ED1, a pre-forward error correction bit error rate of Pre-FEC BER1, a temperature of Temp1, and tap weights of Weights1. A second entry indicates a channel loss of CL2, an impulse response of IR2, a signal-to-noise ratio of SNR2, an optical modulation amplitude of OMA2, a voltage modulation amplitude of VMA2, a forward error correction errors distribution of FED ED2, a pre-forward error correction bit error rate of Pre-FEC BER2, a temperature of Temp2, and tap weights of Weights2. The first entry and the second entry may indicate channel losses, impulse responses, signal-to-noise ratios, optical modulation amplitudes, voltage modulation amplitudes, forward error correction errors distributions, pre-forward error correction bit error rates, and temperatures at a transmission port of the optical module.

The lookup table 402 also includes a third entry indicating a channel loss of CL3, an impulse response of IR3, a signal-to-noise ratio of SNR3, an optical modulation amplitude of OMA3, a voltage modulation amplitude of VMA3, a forward error correction errors distribution of FED ED3, a pre-forward error correction bit error rate of Pre-FEC BER3, a temperature of Temp3, and tap weights of Weights3. The third entry may indicate the channel loss, impulse response, signal-to-noise ratio, optical modulation amplitude, voltage modulation amplitude, forward error correction errors distribution, pre-forward error correction bit error rate, and temperature at a transmission port of the optical module different from the transmission port for the first entry and the second entry. The lookup table 402 may also include entries for different receive ports of the optical module.

As a result, the lookup table 402 may indicate different parameters (e.g., tap weights, optical modulation amplitude settings, voltage modulation amplitude settings, etc.) that may be used to adjust the optical module depending on various operating conditions or characteristics experienced by the optical module at different transmission ports or receive ports of the optical module.

In some embodiments, the lookup table 402 may include additional information in each entry. For example, the lookup table 402 may include settings of a driver of the optical module and the laser current for the optical module. Moreover, the information in the lookup table 402 may be used to determine one or more transfer functions for the optical module.

Generally, a host device may retrieve and/or reference the lookup table 402 to determine operating parameters for an optical module. For example, if the host device determines that a transmission port of the optical module produced a particular impulse response, the host device may reference the lookup table 402 to determine the row or entry of the lookup table 402 indicating an impulse response (e.g., in column 406) that matches or is the most similar to the impulse response at the transmission port. The host device may then set operating parameters of the optical module using the other information in the row or entry. For example, the host device may set tap weights of the equalizer of the optical module using the tap weights indicated in the row or entry (e.g., in column 420).

The host device may reference into the lookup table 402 using any determined operating conditions. For example, the host device may reference into the lookup table 402 using one or more of a determined channel loss, impulse response, signal-to-noise ratio, forward error correction errors distribution, pre-forward error correction bit error rate, and/or temperature. The host device then selects the row or entry with matching or the most similar operating conditions, and the host device sets operating parameters of the optical module using the operating parameters in the selected row or entry.

In some embodiments, the operating parameters of the optical module may be further adjusted (e.g., using link training). The host device may set the operating parameters of the optical module using the operating parameters from the lookup table 402. These operating parameters may represent a starting point for link training, and the link training process may merely refine these operating parameters. Thus, by using the lookup table 402, the host device and the optical module may reduce the time and complexity of the link training process, in certain embodiments.

As an example, there may be different minimums for the same parameter, depending on the different operating conditions across all parameters. The optical power regulation may allow power consumption of the optical module (e.g., as an added parameter) to be reduced while still overcoming any distance or loss impairment. The different regulations may be stored in the lookup table 402 in the optical module. The optical module may make available this information to any host device implementing manual, automatic link optimization or link training, together with relative settings. Link training may be more effective, because the link training may be provided with a clear optimized starting point.

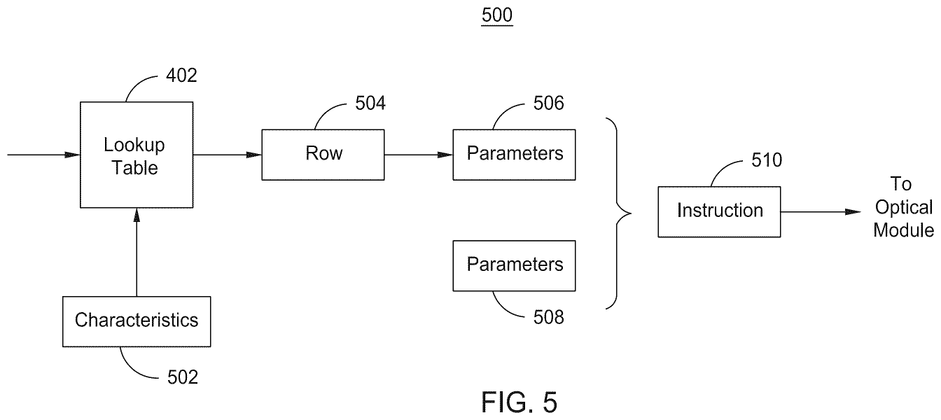

FIG. 5 illustrates an example operation 500 performed by the optical system 100 of FIG. 1. Generally, a host device (e.g., the host device 102A shown in FIG. 1) may perform the operation 500. By performing the operation 500, the host device adjusts an optical module connected to the host device.

The host device begins by retrieving or receiving the lookup table 402 or a portion of the lookup table 402. The host device may retrieve or receive the lookup table 402 from an optical module connected to the host device. For example, the optical module may store the lookup table 402 in a memory of the optical module. When the optical module is inserted into or connected to the host device, the host device retrieves the lookup table 402 from the optical module, or the optical module may communicate the lookup table 402 to the host device.

The host device determines characteristics 502 of the operation of the optical module. For example, the host device may determine certain operating conditions experienced by the optical module, such as an impulse response at a transmission port or receive port of the optical module, a channel loss at the transmission port or receive port, a signal-to-noise ratio at the transmission port or receive port, an optical modulation amplitude at the transmission port or receive port, a voltage modulation amplitude at the transmission port or receive port, a forward error correction errors distribution at the transmission port or receive port, a pre-forward error correction bit error rate at the transmission port or receive port, and/or a temperature of the optical module at the transmission port or receive port.

The host device then references into the lookup table 402 using the determined characteristics 502 to determine an entry of the lookup table 402 that is applicable to the optical module. For example, the host device may determine a row 504 of the lookup table 402 that indicates an impulse response at the transmission port or receive port that matches or is most similar to the impulse response at the transmission port or receive port indicated by the characteristics 502.

The host device may then use the information in the row 504 to adjust the operation of the optical module (e.g., operation at a transmission port or a receive port). For example, the host device may determine one or more parameters 506 from the row 504. The parameters 506 may include tap weights for an equalizer of the optical module, an optical modulation amplitude setting for the optical module, a voltage modulation amplitude setting for the optical module, a laser current for the optical module, etc.

In some instances, the host device may determine one or more parameters 508 for the optical module. The parameters 508 may not be included in the row 504 of the lookup table 402. The host device may determine the parameters 508 from the characteristics 502 and/or the information in the lookup table 402. As an example, the parameters 508 may include optical modulation amplitude settings, voltage modulation amplitude settings, etc.

The host device generates an instruction 510 using the parameters 506 and/or the parameters 508. The instruction 510 may instruct the optical module to adjust certain parameters or settings of the optical module (e.g., equalizer tap weights) according to the instruction 510. In some embodiments, the instruction 510 includes the parameters 506 and/or the parameters 508. The host device communicates the instruction 510 to the optical module, and the optical module adjusts parameters using the parameters 506 and/or the parameters 508 in the instruction 510. In this manner, the host device adjusts the operation of the optical module based on the operating characteristics 502 of the optical module.

In certain embodiments, the host device may perform link training after adjusting the parameters. The adjusted parameters may serve as a starting point for link training, and the link training may further refine these parameters. The adjusted parameters may be close to the post-link training parameters for the optical module, and thus, the adjusted parameters may reduce the time and complexity of the link training process.

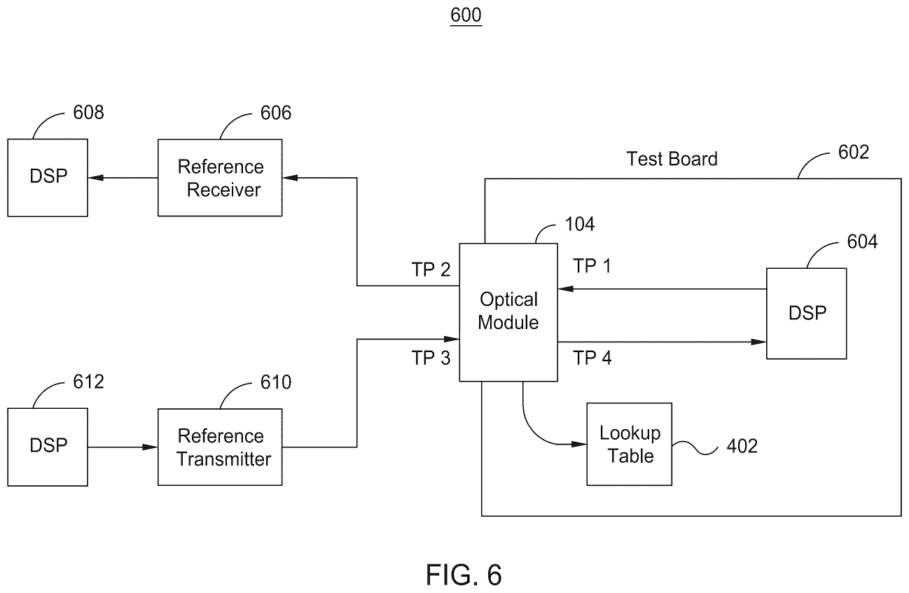

FIG. 6 illustrates an example test system 600. Generally, the test system 600 is used to characterize an optical module and to generate or populate a lookup table stored in the optical module. As seen in FIG. 6, the test system 600 includes the optical module 104, a test board 602, a digital signal processor 604, a reference receiver 606, a digital signal processor 608, a reference transmitter 610, and a digital signal processor 612.

The optical module 104 is attached to the test board 602, which connects the optical module 104 to the digital signal processor 604. The optical module 104 connects to the digital signal processor 604 using two ports labeled TP1 and TP4. TP1 may be a receive port, and TP4 may be a transmission port. Optical fibers or cables are used to connect the optical module 104 to the reference receiver 606 and to the reference transmitter 610. The optical fibers or cables connect to two ports labeled TP2 and TP3. TP2 may be a transmission port, and TP3 may be a receive port. The characteristics of the reference receiver 606 and the reference transmitter 610 may be known. Additionally, the board loss for the test board 602 may also be known.

The reference receiver 606, the reference transmitter 610, and the digital signal processors 604, 608, and/or 612 may then simulate different test conditions for the optical module 104. Generally, the optical module 104 may transmit test signals to the reference receiver 606 while different parameters or settings of the optical module 104 are varied. The digital signal processor 608 and/or reference receiver 606 then monitor how the operating characteristics change based on changes to the parameters or settings of the optical module. The digital signal processor 612 and/or the reference transmitter 610 may also transmit test signals to the optical module 104 while different parameters or settings of the optical module 104 are varied. The digital signal processor 604 then monitors how the operating characteristics change based on changes to the parameters or settings of the optical module. The determined operating characteristics, parameters, and settings may then be stored in the lookup table 402 of the optical module 104.

The functions of the digital signal processor 604 may include forward error correction generation, termination, and monitoring. Different forward error correction processes may be loaded in the digital signal processor 604. The digital signal processor 604 may perform swing regulation and transmitter equalizer regulation, which will allow the digital signal processor 604 to synthesize and emulate different test board 602 losses or roll-off. The digital signal processor 604 may regulate receiver equalizer taps and decision feedback equalizer taps. The digital signal processor 604 may also adjust and monitor thresholds of the optical module 104, and the digital signal processor 604 may monitor forward error correction and signal-to-noise ratios. The digital signal processor 604 may also monitor an impulse response of the optical module 104.

The reference receiver 606 may discriminate and quantify the amount of distortion and noise amplification given by any of the digital signal processors 604, 608, and/or 612 and transmitter branch settings of the optical module 104. The reference receiver 606 may also retrieve the impulse response of the transmitter branch of the optical module 104. The reference receiver 606 may include a calibrated optical power monitor that allows the reference receiver 606 to quantify the amount of distortion and noise amplification of the digital signal processors 604, 608, and/or 612 and settings of the optical module 104 as well as to retrieve the impulse response of the optical module 104.

The digital signal processor 604 at TP1 may be regulated to explore the minimum and maximum foreseen test board 602 lengths, different swings (e.g., voltage modulation amplitudes) and emphasis that makes the input to the optical module 104 compliant to the specs of the optical module 104 (and beyond compliant), so to explore a space of operation.

As an example, the digital signal processor 604 may synthesize different channel losses (e.g., 5 dB, 13 dB, 16 dB, etc.) at TP1, which may result in different impulse responses and noise out of TP1 (e.g., more than one impulse response for a channel loss may be synthesized and considered). Parameters within the optical module 104 may then be adjusted to explore minimum and maximum limits for which equalizer peaking and swing makes the response at TP2 compliant (and beyond compliant) and to record and store the impulse response. The reference receiver 606 may record the optical module's optical power. For each of the parameter adjustments of the optical module 104, the digital signal processor 608 monitors the reference receiver 606 to record the input power, the optical swing or optical modulation amplitude, the tap settings of the equalizer (e.g., of the optical module 104 and of the reference receiver 606), and the forward error correction symbol errors distribution. In some instances, the strength of a decision feedback equalizer may also be monitored and recorded. The digital signal processor 608 may record the impulse response, noise, tap strength, and forward error correction symbol errors distribution. By knowing the characteristics of the reference receiver 606, the impulse response and added noise may define the entire transfer function of the transmitter branch of the optical module 104 (either in the form of a function or in the form of a table). This information is then stored in the lookup table 402 of the optical module 104.

A similar characterization may be run for the receiver branch of the optical module 104. The reference transmitter 610 may send forward error correction traffic to the receive branch of the optical module 104 (e.g., at TP3). The input power and/or optical modulation amplitude may be varied so to characterize the optical module 104 for each of the transimpedance amplifier peaking, swing, and optical modulation amplitude input. The digital signal processor 604 may capture the impulse response, noise, tap strength, and forward error correction symbol errors distribution. These parameters may depend on the input and the transimpedance amplifier adjustments. By knowing the characteristics of the reference transmitter 610, the impulse response and added noise may define the entire transfer function of the receive branch of the optical module 104 (either in the form of a function or in the form of a table). This information is then stored in the lookup table 402 of the optical module 104.

In some instances, one or more parameters are then changed, and the remaining parameters may be tested to create a multi-dimensional space of optimal settings with the main driver to reduce the overall symbol errors distribution. The variation of any of these parameters against input conditions may also be stored as functions.

Another way to characterize the transfer function optical module 104 may be to measure the transfer function analogically. Although the symbol errors and noise characteristics may be difficult to retrieve, other parameters such as total harmonic distortion still allow the transfer function to be determined.

The lookup table 402 may store any type of operating characteristics and conditions and operating parameters. For example, the lookup table 402 may store information for TP1, including an impulse response (e.g., as an array of points indicating weight1, position 1, weight 2, position2, . . . ), a signal-to-noise ratio (e.g., as an array when the signal-to-noise ratio refers to each of the sub-eyes (SNR NRZ)), a voltage amplitude modulation, and the reference synthesized channel used.

For TP2, the lookup table 402 may store the impulse response, settings for the transmitter driver of the optical module 104, and laser current. In this manner, twelve combinations of the driver settings and laser current may generate, for each impulse response, an output impulse response, an output signal-to-noise ratio, so to include the information of the introduced compression, and the optical modulation amplitude. For this example, applying the variables to six input cases will produce a total of seventy-two combinations to be stored for TP2. As the number of combinations grows, specific functions can be determined from the combinations to define formulas, which may then be stored instead of the lookup table 402.

For TP4, the lookup table 402 may present similar information as for TP2, but the variables may be optical modulation amplitude at the input, transimpedance amplifier gain, and peaking. In this manner, twelve combinations of the variables may generate, for each impulse response, an output impulse response, an output signal-to-noise ratio, and a voltage modulation amplitude. Thus, as for TP2, each of the combinations may be used to generate functions and some new information specific of the reference test system. This information may be specific of the optical module 104 and may depend on the digital signal processor 608, yet can be used by the host to understand how the optical module 104 would potentially drive the host towards a specific taps region that would lead into less or more errors. As with TP2, by knowing the input impulse response and the output impulse response at TP4, the optical module 104 is characterized in terms of transfer function and added noise/distortion.

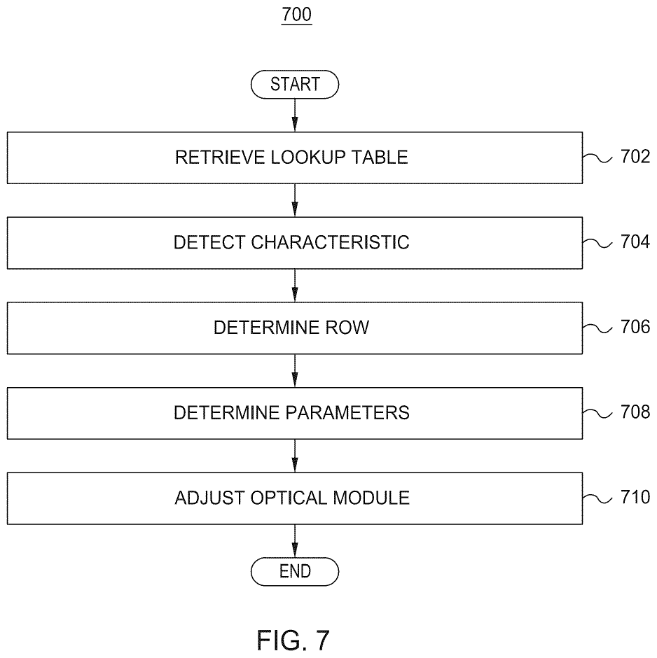

FIG. 7 is a flowchart of an example method 700 performed by the optical system 100 of FIG. 1. In certain embodiments, a host device (e.g., the host device 102A shown in FIG. 1) perform the method 700. By performing the method 700 the host device uses a lookup table stored in an optical module to adjust the optical module.

At 702, the host device retrieves a lookup table from an optical module connected to (e.g., inserted into) the host device. The lookup table may include rows or entries indicating various operating parameters (e.g., equalization parameters such as tap weights, optical modulation amplitudes, voltage modulation amplitudes, etc.) for different operating characteristics or conditions (e.g., impulse responses, channel losses, noise levels, temperatures, errors distributions, bit error rates, etc.) experienced by the optical module at different ports (e.g., transmission ports or receive ports) of the optical module. In some embodiments, the host device retrieves a subset or a portion of the lookup table instead of the entire lookup table.

At 704, the host device detects a characteristic or condition of the operation of the optical module. For example, the host device may determine an impulse response at a port of the optical module. In some instances, if the lookup table is not available or if the characteristic or condition cannot be determined, then the host device may keep or regulate the settings of the optical module (e.g., transimpedance gain, voltage amplitude modulation, etc.) at optimum or default values.

At 706, the host device determines a row of the lookup table that is applicable to the determined characteristics. Using the previous example, the host device may determine the row or entry of the lookup table that matches or comes closest to the determined impulse response at the port of the optical module.

At 708, the host device determines parameters for the optical module using the information in the determined row of the lookup table. The determined parameters may be included in the row or entry of the lookup table. Some of the determined parameters may be determined from the information in the row or entry of the lookup table. Some of the determined parameters may be determined from the operating characteristics or conditions. Using the previous example, the host device may determine equalization parameters for an equalizer of the optical module using the information in the determined row or entry.

At 710, the host device adjusts the optical module using the determined parameters. For example, the host device may include the determined parameters in an instruction and communicate the instruction to the optical module. The optical module may then set certain operating parameters based on the instruction. Using the previous example, the host device may include equalization parameters for an equalizer of the optical module in the instruction. The optical module may then set the equalization parameters of the equalizer of the optical module based on the equalization parameters in the instruction. In this manner, the host device adjusts the parameters of the optical module to improve the linearity of the optical module.

The host device may adjust any parameter of the optical module. For example, the host device may adjust equalization parameters (e.g., tap weights), laser current, optical modulation amplitude, transimpedance amplifier settings, power, variable gain amplifier gain, etc.

In some embodiments, the optical module may then perform link training to further refine the operating parameters (e.g., the equalization parameters). Because the equalization parameters determined by the host device may be close to the post-link training equalization parameters for the optical module, the equalization parameters determined by the host device may serve as a starting point for the link training, which may reduce the time and complexity of the link training.

In summary, the optical module 104 includes (e.g., a linear transmitter optical module, linear receive optical module, linear pluggable optical module, etc.) a memory that stores a lookup table of parameters for different operating conditions experienced by the optical module 104. For example, the lookup table may include operating parameters for different impulse responses or channel losses. When the optical module 104 is connected to a host device 102, the host device 102 may determine the impulse response of the optical module 104, and the host device 102 may determine, from the lookup table, the operating parameters that correspond to the determined impulse response. The host device 102 may then adjust the optical module 104 (e.g., adjust the equalizer of the optical module) using these operating parameters.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An optical module comprising:
an equalizer arranged to adjust a first electrical signal;
a first driver arranged to adjust the first electrical signal received from the equalizer;
a modulator arranged to produce a first optical signal based on the first electrical signal received from the first driver; and
a memory arranged to store a lookup table that includes:
a first entry indicating a first impulse response at a transmission port of the optical module and a first equalization parameter for the first impulse response; and
a second entry indicating a second impulse response at the transmission port and a second equalization parameter for the second impulse response.

2. The optical module of claim 1, wherein the lookup table further includes a third entry indicating (i) a third impulse response at a second transmission port of the optical module and (ii) a third equalization parameter for the third impulse response.

3. The optical module of claim 1, wherein the first entry further indicates a bit error rate for the first impulse response.

4. The optical module of claim 1, wherein the first entry further indicates (i) a signal-to-noise ratio for the first impulse response, (ii) an optical modulation amplitude for the first impulse response, and (iii) a voltage modulation amplitude for the first impulse response.

5. The optical module of claim 1, further comprising:
a photodiode arranged to produce a second electrical signal based on a second optical signal;
a transimpedance amplifier arranged to convert the second electrical signal into a third electrical signal; and
a second driver arranged to adjust the third electrical signal received from the transimpedance amplifier.

6. The optical module of claim 1, wherein the first equalization parameter is further for adjusting the equalizer.

7. The optical module of claim 6, wherein adjusting the equalizer comprises adjusting a tap weight of the equalizer using the first equalization parameter.

8. A device comprising:
one or more memories; and
one or more processors communicatively coupled to the one or more memories, the one or more processors configured to, individually or collectively, perform an operation comprising:
retrieving, from an optical module connected to the device, a portion of a lookup table stored in a memory of the optical module, wherein the portion of the lookup table includes:
a first entry indicating a first impulse response at a transmission port of the optical module and a first equalization parameter for the first impulse response; and
a second entry indicating a second impulse response at the transmission port and a second equalization parameter for the second impulse response; and
adjusting, by the device, an equalizer of the optical module using the retrieved portion of the lookup table.

9. The device of claim 8, wherein the lookup table further includes a third entry indicating (i) a third impulse response at a second transmission port of the optical module and (ii) a third equalization parameter for the third impulse response.

10. The device of claim 8, wherein the first entry further indicates a bit error rate for the first impulse response.

11. The device of claim 8, wherein the first entry further indicates (i) a signal-to-noise ratio for the first impulse response, (ii) an optical modulation amplitude for the first impulse response, and (iii) a voltage modulation amplitude for the first impulse response.

12. The device of claim 8, wherein the operation further comprises determining an impulse response of the optical module at the transmission port.

13. The device of claim 8, wherein adjusting the equalizer comprises adjusting a tap weight of the equalizer using the first equalization parameter.

14. The device of claim 8, wherein the operation further comprises adjusting a transimpedance amplifier of the optical module using the retrieved portion of the lookup table.

15. A method comprising:
retrieving, by a host device and from an optical module connected to the host device, a portion of a lookup table stored in a memory of the optical module, wherein the portion of the lookup table includes:
a first entry indicating a first impulse response at a transmission port of the optical module and a first equalization parameter for the first impulse response; and
a second entry indicating a second impulse response at the transmission port and a second equalization parameter for the second impulse response; and
adjusting, by the host device, an equalizer of the optical module using the retrieved portion of the lookup table.

16. The method of claim 15, wherein the lookup table further includes a third entry indicating (i) a third impulse response at a second transmission port of the optical module and (ii) a third equalization parameter for the third impulse response.

17. The method of claim 15, wherein the first entry further indicates a bit error rate for the first impulse response.

18. The method of claim 15, wherein the first entry further indicates (i) a signal-to-noise ratio for the first impulse response, (ii) an optical modulation amplitude for the first impulse response, and (iii) a voltage modulation amplitude for the first impulse response.

19. The method of claim 15, wherein adjusting the equalizer comprises adjusting a tap weight of the equalizer using the first equalization parameter.

20. The method of claim 15, further comprising determining, by the host device, an impulse response of the optical module at the transmission port.
